(19) United States
(12) Patent Application Publication
(10) Pub. No.: US 2006/0013541 A1
(43) Pub. Date: Jan. 19, 2006

(54) Optoelectronic module

(75) Inventors: Volker Plickert, Brieselang (DE); Lutz Melchior, Berlin (DE)

Correspondence Address: BEVER, HOFFMAN & HARMS, LLP, 1432 CONCANNON BLVD, BUILDING G, LIVERMORE, CA, 94550-6006, US

(73) Assignee: Infineon Technologies Fiber Optics GmbH, Berlin (DE)

(21) Appl. No.: 11/022,580

(22) Filed: Dec. 22, 2004

Related U.S. Application Data
(60) Provisional application No. 60/588,784, filed on Jul. 16, 2004.

(51) Int. Cl. G02B 6/26

(52) U.S. Cl. 385/89; 385/47

(57) ABSTRACT

An optoelectronic module for optical signals of two optical data channels, the module having a first submodule, which generates or detects optical signals of a first data channel, a second submodule, which generates or detects optical signals of a second data channel, a coupling device for coupling an optical waveguide, a housing, to which the first submodule, the second submodule and the coupling device are mechanically fixed, and a beam splitting device arranged in the housing. The beam splitting device effects beam splitting and light deflection in such a way that a signal transfer is effected on the one hand between the first submodule and a coupled optical waveguide and on the other hand between the second submodule and the coupled optical waveguide, the light of both data channels being multiply deflected in the beam splitting device.

### RELATED APPLICATION

The present application claims priority of U.S. Patent Application Ser. No. 60/588,784 filed by Volker Plickert and Lutz Melchior on Jul. 16, 2004.

### FIELD OF THE INVENTION

The invention relates to an optoelectronic module for optical signals of two optical data channels. In particular, the invention provides a bidirectional module for a transceiver of SFF or SFP design that can also be used in passive optical networks.

### BACKGROUND OF THE INVENTION

So-called small form factor (SFF) transceivers and small form factor pluggable (SFP) transceivers of small design are known. The transceivers may be of pluggable design (SFP transceivers) or be fixedly arranged in a housing on a printed circuit board (SFF transceivers). The known transceivers have, in addition to an optoelectronic transmitting module and an optoelectronic receiving module an internal printed circuit board that runs parallel to the optical axis of the transceiver and contains electronic circuits for the converter module, such as a driver module and/or a preamplifier module. The transceiver is arranged all together on a main circuit board, which is electrically connected to the internal printed circuit board via a plug, for example. An SFP transceiver is described in DE 101 14 143 A1, for example.

There is a need for arrangements in which an SFF or SFP transceiver is provided with a bidirectional module that contains both the transmitter and the receiver and transmits and receives data via just one connected optical waveguide.

At the same time, it is endeavored to be able use such SFF or SFP transceivers in passive optical networks (PON) as well. In contrast to a point-to-point transfer, in passive optical networks a transmitter in a central office (network node) transfers data simultaneously to a plurality of receivers, the optical branching network only comprising optical fibers, plugs and passive coupling and branching elements for linking the individual subscribers. The necessary use of light couplers and splitters greatly increases the requirements made of the individual modules in PON networks with regard to optical power and receiver sensitivity. In contrast to bidirectional modules for a point-to-point transfer, the transmitter must have in particular a good coupling efficiency, that is to say couple a high optical power into the fiber. Equally, the receiver must have a high sensitivity to the signal to be received. At the same time, transmitter and receiver must be well screened relative to one another.

EP A 0 463 214 describes a transmitting and receiving module for a bidirectional optical signal transfer, which is known as BIDI-module. In the case of this module, the two active components, namely light transmitter and light receiver, are incorporated as independent components in a manner hermetically tightly encapsulated in a common module housing, in the interior of which a beam splitter and a lens coupling optical system are arranged. The module housing furthermore has a fiber connection for a common optical fiber. One optical signal is coupled into the coupled optical fiber by the transmitter, while at the same time another optical signal can be received from the same fiber. The two signals are separated by a beam splitter, which may also contain a wavelength-selective filter that reflects a specific wavelength and allows another wavelength to pass. It is disadvantageous that modules of this type are too large to be used in SFF or SFP transceiver modules.

Furthermore, bidirectional modules are known in which a transmitter and a receiver are incorporated in a common housing, for example a customary TO housing with a window cap. The transmitted and received optical signals are separated from one another by means of a beam-splitting element in the common housing. A plug bay for coupling an optical plug may be adjusted and fixed directly to such a TO housing. Moreover, such a module is small enough to be incorporated in a transceiver module of SFF or SFP design. What is disadvantageous, however, is that the optoelectronic performance of such bidirectional assemblies is not outstanding. Since the transmitting group and the receiving group are seated in a common housing, electrical crosstalk can be avoided only with difficulty. The restricted sensitivity and the limited optical power have the effect that such modules are preferably used for point-to-point applications.

WO02/095470 A1 discloses an electro-optical module for the transmission and/or reception of optical signals of at least two optical data channels, in which at least two optical waveguide sections having in each case at least one beveled end area are provided. The optical waveguide sections are positioned axially one behind the other at the beveled end areas in a small optical tube. For a specific optical channel, light is coupled in and light is coupled out at the beveled end area of an optical waveguide section perpendicular to the optical axis of the optical waveguide. In this case, the end area is coated with a wavelength-selective filter for wavelength separation purposes. What is disadvantageous about this arrangement is that use in a transceiver module of SFF or SFP design is difficult to realize. In particular, the small tube with the optical waveguide cannot be arranged centrally in the module for space reasons.

It is endeavored to provide modules of SFF or SFP design for data transfer which are distinguished by a simple construction, low production costs and a high coupling efficiency to an optical waveguide, the intention also being to enable use in passive optical networks.

### SUMMARY OF THE INVENTION

The invention provides an optoelectronic module for optical signals of two optical data channels having a first submodule, which generates or detects optical signals of a first data channel, a second submodule, which generates or detects optical signals of a second data channel, a coupling device for coupling an optical waveguide, a housing, to which the first submodule, the second submodule and the coupling device are mechanically fixed, and a beam splitting device which is arranged in the housing. The beam splitting device effects beam splitting and light deflection in such a way that a signal transfer is effected on the one hand between the first submodule and a coupled optical waveguide and on the other hand between the second submodule and the coupled optical waveguide, the light of both data channels being multiply deflected in the beam splitting device.

The first submodule is preferably a transmitting module that generates optical signals of a first data channel, and the second submodule is preferably a receiving module that detects optical signals of a circuit data channel. The beam splitting device then effects beam splitting and light deflection in such a way that light of the first data channel that has been emitted by the transmitting module is coupled into a coupled optical waveguide and, at the same time, light of the second data channel that has been received via the coupled optical waveguide is fed to the receiving module, the light of both data channels being multiply deflected in the beam splitting device.

However, it is equally possible to provide two transmitting modules or two receiving modules that transmit or detect light having different wavelengths. The module according to the invention then operates as a multiplexer or demultiplexer.

The present invention is based on the concept of using hermetically encapsulated submodules of standard construction for the transmitting module and the receiving module, which submodules satisfy the requirements to be met in respect of the optoelectronic performance and the electrical screening. By way of example, for this purpose use is made of TO housings with tried and tested subassemblies for the transmitter and the receiver. The prefabricated transmitting module and the prefabricated receiving module are mechanically fixed together with a coupling device for coupling an optical waveguide on the exterior of a common housing. A beam splitting device that performs beam splitting with regard to the light of the two data channels is situated in the housing. In this case, the optical axes of the transmitting module, of the receiving module and of the coupling device are preferably oriented parallel to one another.

An arrangement for data transfer is provided in which good screening between the submodules, in particular between the transmitting module and the receiving module, is present and a compact construction is nevertheless provided, in particular also for an SFF design or an SFP design. The good screening between the submodules also enables use for passive optical networks. Partial recourse to standard submodules furthermore enables the module according to the invention to be provided cost-effectively.

The use of known TO housings for the submodules furthermore has the advantage that it is possible to resort to known solutions for electrical coupling to the printed circuit board of a transceiver in which the module according to the invention is arranged. In particular, the pins of the TO modules can be soldered onto such a module printed circuit board directly or via a flexible conductor.

It is pointed out that the beam splitting device arranged in the module housing, in one embodiment, may consist of an assembly or an arrangement of components located at inner walls of the housing. In such embodiment, the beam splitting device does not include a main body to which components of the beam splitting device are connected. Instead, the components of the beam splitting device are connected to inner walls of the housing. In another embodiment, the beam splitting device arranged in the module housing comprises a main body located inside the housing, with components of the beam splitting such as filters and mirrors being connected to such main body.

In the preferred embodiment, the coupling device is arranged centrally with regard to the housing. The optical axes of the first submodule and of the second submodule are arranged offset with respect to the optical axis of the coupling device. In this case, the light of both data channels is deflected twice in the beam splitting device. The central arrangement of the coupling device enables an optical waveguide to be coupled in a readily manipulable fashion, which optical waveguide is coupled to the coupling device via an optical plug.

The housing of the module according to the invention is preferably a metallic housing on which the submodules and the coupling device are fixedly arranged and adjusted with respect to one another.

The beam splitting device is preferably formed as a monolithic plastic part. In particular, what is involved is a molded plastic part produced by means of a master mold technique. Such a monolithic plastic part can be produced simply and cost-effectively.

In a preferred embodiment, the beam splitting device has a wavelength-selective filter, which is optically coupled to the coupling device and is fixed to an obliquely running area of the beam splitting device. Said filter is transmissive to the light of one data channel and reflective to the light of the other data channel. In this case, the light is reflected between the wavelength-selective filter and the associated module for each data channel at at least one obliquely running reflective area of the beam splitting device.

The oblique area preferably runs at an angle of 450 to the incident light beam. The wavelength-selective filter, which is a WDM filter, for example, separates the optical paths for the transmitting module and the receiving module.

A glass lamina with a mirror for beam deflection is preferably in each case arranged at the obliquely running reflective areas. Equally, the wavelength-selective filter is formed on a glass lamina arranged at the associated obliquely running area of the beam splitting device. The respective glass lamina is adhesively bonded onto the associated obliquely running area by means of a transparent, index-matched adhesive. This embodiment has the advantage that unevennesses in the surface of the plastic part are compensated for by the separate filters and mirrors and also the index-matched adhesive. The requirements made of the surface roughness of the plastic part can be reduced and the latter can be produced even more cost-effectively. Moreover, the separate mirrors and filters can be produced simply and cost-effectively.

In principle, however it is equally possible for the wavelength-selective filter and the mirrors to be applied directly on the corresponding areas of the plastic part.

In a preferred embodiment, the light of one data channel that has been transmitted through the wavelength-selective filter is coupled to the associated module by means of two further obliquely running reflective areas of the beam splitting device. The light of the other data channel that has been reflected at the wavelength-selective filter is preferably coupled to the associated module by means of a further obliquely running reflective area of the beam splitting device. In both cases, the light overall is deflected twice at areas of the beam splitting element.

In a further preferred embodiment, the housing includes one or several walls surrounding a hollow interior, wherein the beam splitting device consists of components located inside the hollow interior and attached to the inside of the housing wall or walls. Preferably, the components comprise at least one wavelength selective filter and a plurality of mirrors, wherein the wavelength selective filter and the mirrors are attached to planar stop areas formed at the inside of the housing wall or walls. In this embodiment, a monolithic part inside the housing is not required and, instead, optical signals between components of the beam splitting device are transmitted through the hollow interior of the housing.

In one embodiment, at least one the planar stop areas includes a cutout filled with an adhesive which serves into adhesively bond the respective filter or mirror to the respective planar stop area.

In a preferred embodiment, there are provided four stop areas, a first of said stop areas carrying a wavelength selective filter and the other stop areas each carrying a mirror, wherein the wavelength-selective filter is transmissive to the optical signals of one of the first and second data channels and is reflective to the optical signals of the other of the first and second data channels, the optical signals being reflected between the wavelength-selective filter and the associated submodule for one of the first and second data channels by first and a second obliquely arranged mirrors and for the other of the first and second data channels by a third obliquely arranged mirror.

In a further preferred embodiment, optical signals of at least one of the first and second data channel are reflected at a component of the beam splitting device at an angle below 90°. Preferably, optical signals of each of the first and second data channel are reflected twice by components of the beam splitting device, each reflection taking place at an angle below 90°, wherein the optical signals after the twofold reflection run exactly parallel to their original direction. The reflection of the light beams inside the housing under an angle below 90° allows to reduce the overall length of the housing.

The first submodule is preferably formed as a TO module with a TO housing and a transmitting or receiving assembly arranged in the TO housing, the TO housing forming a stop area with which it is fixed to a planar outer stop area of the housing. Equally, the second submodule is preferably formed as a TO module with a TO housing and a transmitting or receiving assembly arranged in the TO housing, the TO housing forming a stop area with which it is fixed to a further planar outer stop area of the housing. In this case, the TO housings have metal caps and the TO housings can be fixed to the module housing by laser welding.

The coupling device preferably has an integrated fiber stub and also a lens that shapes light emerging from the fiber stub to form a parallel beam of rays. The optical waveguide of a coupled optical plug is arranged in a manner adjoining the fiber stub.

However, embodiments without an integrated fiber stub are also possible. In principle, any desired optical plugs can be used, it being necessary to form the coupling device in accordance with the optical plug to be used.

### BRIEF DESCRIPTION OF THE DRAWINGS

The invention is explained in more detail below using exemplary embodiments with reference to the figures, in which:

FIG. 1 shows a sectional view of a a first embodiment of a bidirectional optoelectronic module with a transmitting module, a receiving module, a coupling device for coupling an optical waveguide and also a beam splitting device arranged in a housing;

FIG. 2 shows the beam splitting device and the transmitting module and the receiving module of FIG. 1 without the further components;

FIG. 3 shows a side view of the bidirectional module of FIG. 1;

FIG. 4 shows a perspective view of the beam splitting device, the transmitting module and the receiving module of FIG. 2;

FIG. 5 shows a perspective arrangement of the complete optoelectronic module in accordance with FIG. 1;

FIG. 6 shows a sectional view of second embodiment of a bidirectional optoelectronic module with the transmitting module, a receiving module, a coupling device for coupling an optical waveguide and a beam splitting device arranged in a housing, the sectional view being taken along the line G-G of FIG. 7; and

FIG. 7 a side view of the bidirectional module of FIG. 6.

### DESCRIPTION OF PREFERRED EXEMPLARY EMBODIMENTS

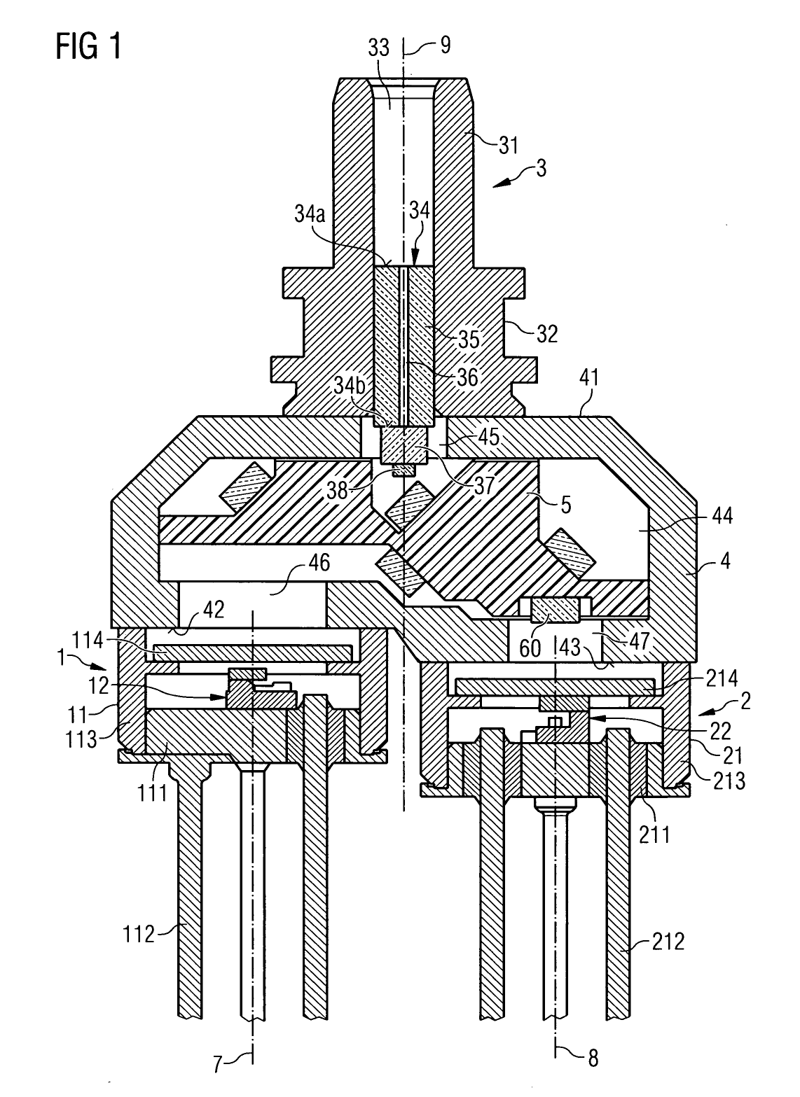

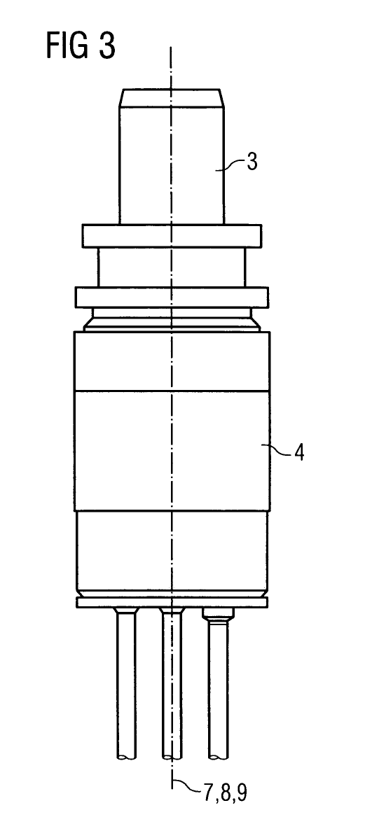

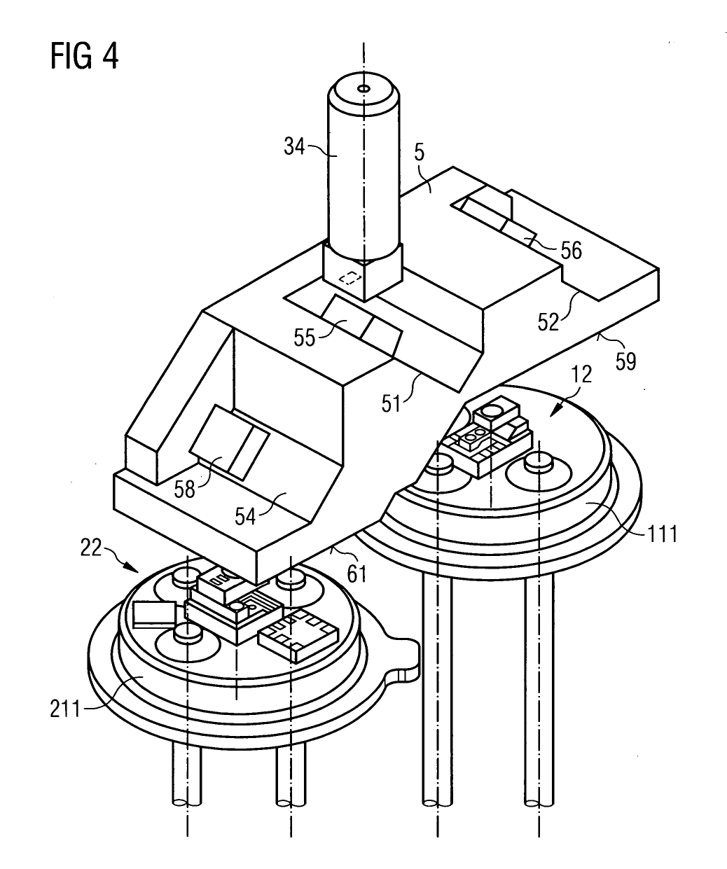

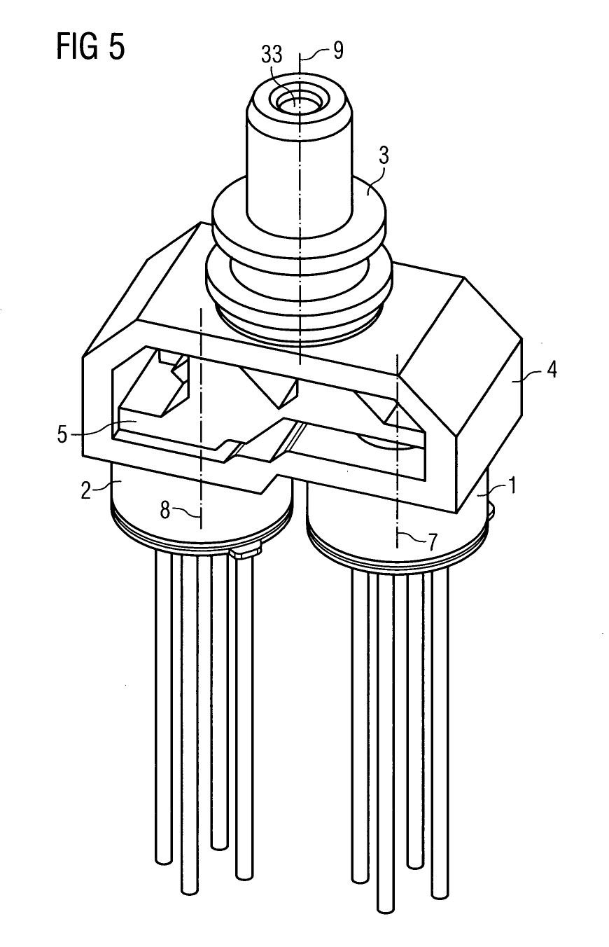

The optoelectronic device for bidirectional data transfer as illustrated in FIGS. 1 to 6 has, as essential components, a transmitting module 1, a receiving module 2, a coupling device 3—also referred to as receptacle—for coupling an optical waveguide, a housing 4 and a beam splitting device 5.

The transmitting module 1 and the receiving module 2 are in each case formed in a TO design. A TO46 design is preferably used. The transmitting module 1 comprises a TO housing 11 and a transmitting assembly 12. The TO housing has a TO baseplate 111 (also referred to as TO header), into which housing pins 112 for electrically linking the module are introduced, and a metallic cap 113 with a glazed window 114. In this case, the metallic cap 113 is not a standard cap: it has a weldable area at its end facing the housing 4. The 113 is welded onto the baseplate 111.

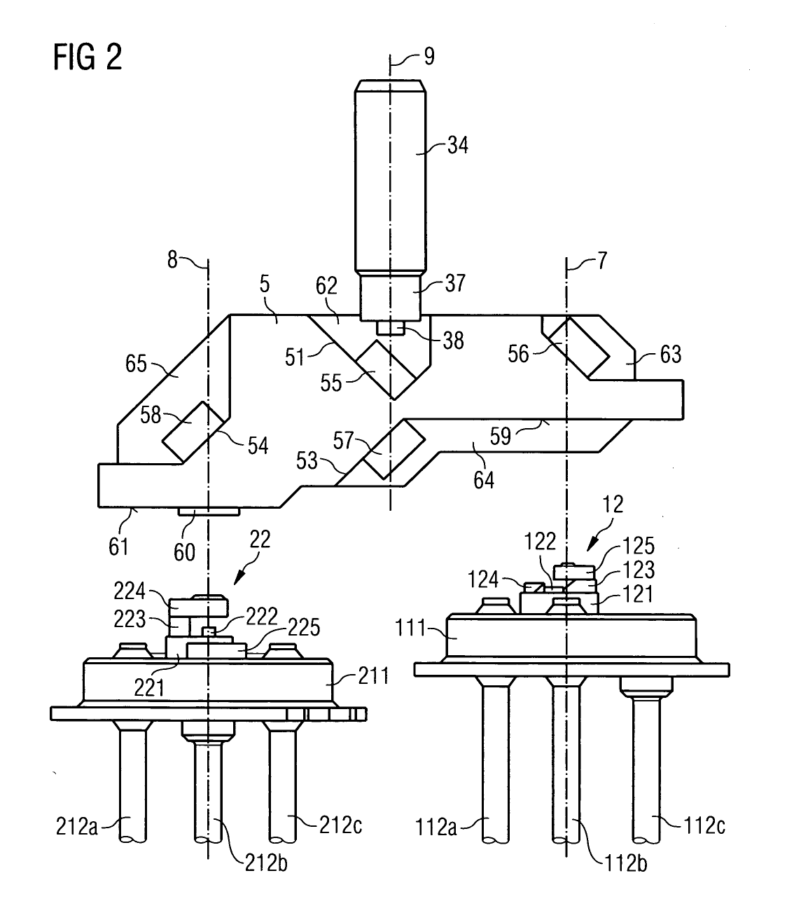

As can also be seen from FIG. 2 (which is laterally reversed with respect to FIG. 1), the transmitting assembly 12 comprising a submount 121, an edge emitting laser 122, a deflection prism 123 and a monitor diode 124 is mounted on the baseplate 111. A planar lens 125, preferably a silicon lens, is adjusted and fixed on the deflection prism 123. The cap 113 with the glazed window 114 is welded on the baseplate 111, so that the interior of the housing is hermetically encapsulated.

In a corresponding manner, the receiving module 2 likewise has a TO housing 21 having a baseplate 211 with glazed pins 212 and a metallic cap 213 with a glazed window 214, which is welded on the baseplate 211 and forms a hermetically closed-off interior. The cap 213 once again has a weldable area at its end facing the housing 4. A receiving assembly 22 having a submount 221, a photodiode 222, a spacer 223 and a silicon lens 224 is arranged on the baseplate 211. In the exemplary embodiment illustrated, but not necessarily, a preamplifier IC 225 is additionally mounted on the baseplate 211.

In the exemplary embodiment illustrated, the coupling device 3 is formed by a rotationally symmetrical coupling part 31 with a central hole 33, in which a so-called fiber stub 34 is arranged. The fiber stub 34 comprises a ferrule 35 or glass capillary 35, in which a single-mode optical waveguide 36 is arranged. The optical waveguide 36 is polished flush with the glass capillary 35 at the end areas 34a, 34b of the fiber stub 34. The coupling device 3 has a specific peripheral contour 32 serving for coupling and mechanically latching a specific optical plug. The contour illustrated in the exemplary embodiment serves for example for coupling and mechanically latching an LC plug.

A glass lamina 37, also referred to as a spacer, is mounted at that side of the fiber stub 34 which faces the housing 4. A planar lens 38 preferably formed as a planar silicon lens is situated on the glass lamina 37, said lens focusing the light emerging from the optical waveguide 36. The focal length and the thickness of the glass lamina 37 and of the lens 38 are dimensioned such that a parallel light beam is generated.

The housing body 4 is formed in such a way that, in terms of its dimensions, it fits into an SFP or SFF housing having a width of 14 mm.

The housing 4 forms a plurality of stop areas (walls) 41, 42, 43 that serve for coupling and fixing the coupling device 3, the transmitting module 1 and the receiving module 2. Thus, provision is made of an upper plane stop area 41 for coupling the coupling device 3, a first lower plane stop area 42 for coupling the transmitting module 1 and a second lower plane stop area 43 for coupling the receiving module 3. In this case, each stop area has an opening 45, 46, 47 that serves for passage of light and coupling of light between the beam splitting device 5, on the one hand, and the coupling device 3, the transmitting module 1 and the receiving module 2, on the other hand.

The optical axis 7 of the transmitting module 1, the optical axis 8 of the receiving module 2 and the optical axis 9 of the coupling device 3 are oriented parallel to one another and lie in a common plane. At the same time, the axes 7, 8 of the transmitting module 1 and of the receiving module 2 in each case lie laterally with respect to the axis 9 in the coupling device, which is arranged centrically with respect to the housing 4.

The interior of the housing 4 forms a cavity 44, in which the beam splitting device 5 is situated and in which the latter is fixed. The beam splitting device 5 is preferably formed as a monolithic plastic part composed of a plastic that is transparent to the wavelengths under consideration. Production is effected by means of a master mold method, for example using injection molding technology. In principle, however, the beam splitting device 5 may also be joined together from a plurality of parts, good optical matching then being present between said parts.

The beam splitting device 4, also referred to hereinafter as plastic monolith, has, in accordance with FIG. 2, a plurality of cutouts 62, 63, 64, 65 that in each case form oblique areas 51, 52, 53, 54 running at an angle of 45° to the axes 7, 8, 9.

A first such 45° area 51 is formed adjacent to the coupling device 3 and the fiber stub 34 thereof with glass lamina 37 and planar lens 38. A wavelength-selective filter 55, which separates the optical paths for the transmitting module 1 and the receiving module 2, is fixed on the 45° area. The wavelength-selective filter 55 is preferably a WDM filter (WDM—wavelength division multiplex) which can separate from one another even wavelengths that are close together.

In principle, the WDM filter 55 may be formed directly on the obliquely running area 51. However, it is preferably provided, in accordance with the exemplary embodiment illustrated, that the WDM filter 55 is provided by a separate part that is fixed on the first 45° area 51 by means of a transparent, index-matched adhesive. In this case, the separate part is a glass lamina, for example. The advantage is that the requirements with regard to the surface roughness and angular accuracy of the obliquely running area 51 are reduced, which in turn reduces the requirements made of the accuracy of the molded plastic part. Thus, the influence of the surface roughness is reduced by using an optically transparent adhesive that has the same refractive index as the plastic monolith 5 and therefore simultaneously serves for index matching. Unevennesses both in the surface of the obliquely running area 51 and in the surface of the filter are compensated for.

Second, third and fourth 45° areas 52, 53, 54 are formed in the further cutouts 63, 64, 65. The further obliquely running areas 52, 53, 54 serve as reflective mirror areas at which the light is deflected through 90°. In this case, provision is once again made for forming the mirrors at separate glass laminae 56, 57, 58 that are adhesively bonded onto the respective obliquely running area 52, 53, 54 by means of an index-matched adhesive. Here, too, it holds true that unevennesses in the surface of the plastic monolith are compensated for by using a transparent, index-matched adhesive and the requirements with regard to the surface roughness that are made of the monolith are correspondingly reduced. The mirrors 56, 57, 58 are produced for example by vapor deposition of mirror layers onto large substrates and subsequent sawing into small units.

A block filter 60 is additionally situated on a lower plane area 61 of the monolith 5 that faces the receiving module 2. The block filter 60 is transparent only to the wavelength of the received light and blocks light having the wavelength of the light transmitted by the transmitting module 1. This ensures a high optical crosstalk attenuation.

During operation, an optical plug with an optical waveguide is coupled to the coupling device 3. In this case, an optical waveguide of the optical plug passes into the central hole 33 of the coupling part 31 and such that it bears directly against the upper end area 34a of the fiber stub 34.

The coupling device 3, the transmitting module 1 and the receiving module 2 are adjusted with respect to one another and fixed to the housing 4 in such a way that the light radiated from the coupled optical waveguide passes onto the photosensitive area of the photodiode 222 and, at the same time, the light emitted by the laser 122 is coupled into the optical waveguide.

In this case, the received light emerging from the fiber stub 34 firstly radiates through the glass lamina 37 and is collimated by the lens 38 to form a parallel beam. The light passes as a parallel beam onto the WDM filter 55. Said filter 55 permits the light wavelength of the received light to pass, so that the light radiates through the WDM filter 55 rectilinearly. The light beam then passes into the plastic monolith 5 and is deflected by 45° in each case at the mirrors 57, 58 arranged at the areas 53, 54. Consequently, what is effected is a double deflection by 90° and correspondingly as a result an offset by the distance between the two axes 8, 9 of coupling device 3 and receiving module 2. Before being coupled into the receiving module 2, the received light passes through the block filter 60, in order to filter out undesirable wavelengths, and also one lower opening 47 in the module housing 4. The light is then detected by the receiving module 3 in a manner known per se.

The light of the transmitting module that has been emitted by the laser 122 is deflected at the 45° mirror of the deflection prism 123, collimated by the lens 125 to form a parallel beam, radiates through the window 114 of the cap 113 and also the opening 46 of the assigned stop area 42 of the housing 4 and then enters the plastic monolith 5 through one lower plane area 59. The light is reflected through 90° at the 45° area 52 and the mirror 56 provided there and is directed onto the WDM filter 55. The WDM filter 55 is reflective to the wavelength of the emitted light and correspondingly reflects the light in the direction of the fiber stub 34. In this way, the light is coupled into the fiber stub 34 and the coupled optical waveguide. In this case, the light emitted by the transmitting module 1 is also deflected twice, in each case by 90°, and so overall an offset corresponding to the distance between the optical axes 7, 9 of transmitting module 1 and coupling device 3 is provided.

Of course, the WDM filter 55 may alternatively also be formed such that the received light is reflected and the transmitted light can pass through the filter. The plastic monolith is then formed such that the received light is reflected once and the emitted light is reflected twice at mirrors.

The sequence of construction is as follows. Firstly, the transmitting module 1 is fixed to the housing body 4. For this purpose, the upper peripheral area of the cap 113 of the TO housing 11 is welded onto the associated stop area 42. In a second step, the receptacle 3 is adjusted with its stop area at the assigned upper stop area 41 of the housing 4 in the x-y direction in such a way that a maximum of power is coupled into the fiber stub 34 and a coupled optical fiber. For this purpose, the laser module is operated and the optical power of the light in the optical fiber is measured (active adjustment). In a third step, the receiving module 2 is arranged at the associated stop area 43 of the housing and actively displaced in the plane of the stop area 43 such that a maximum of the light coupled out from the coupled optical waveguide passes onto the photodiode 222. The receiving module 2 is then fixed in the suitable position.

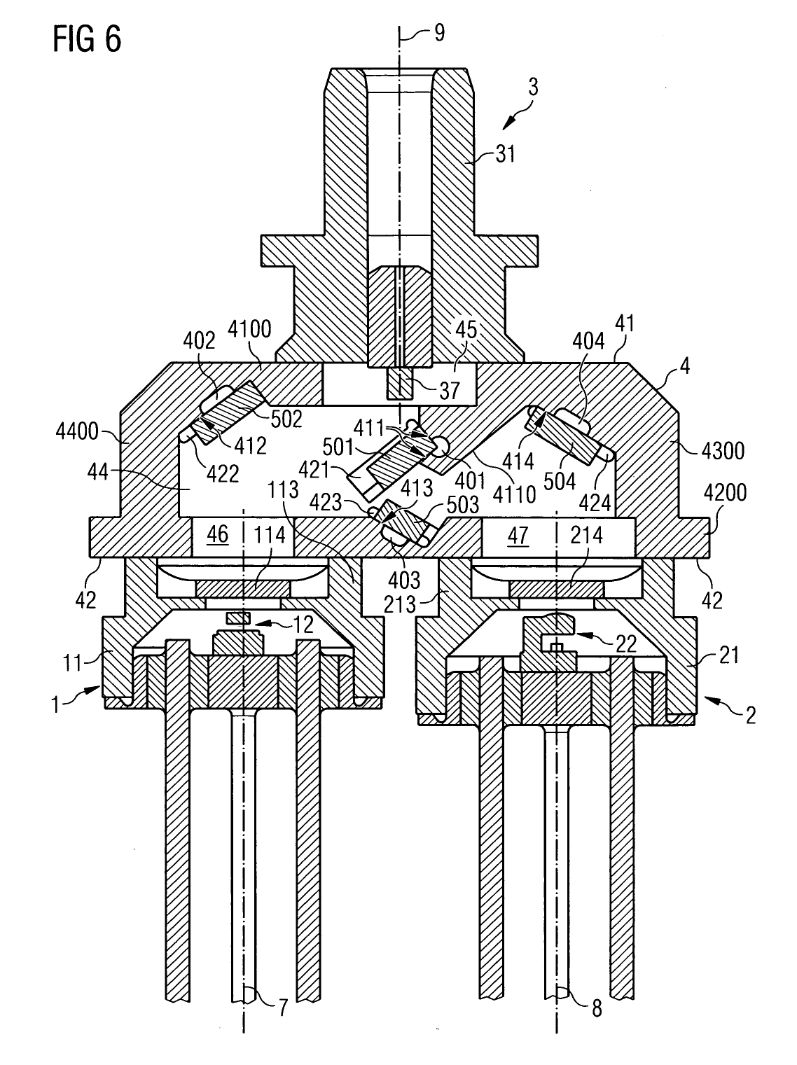

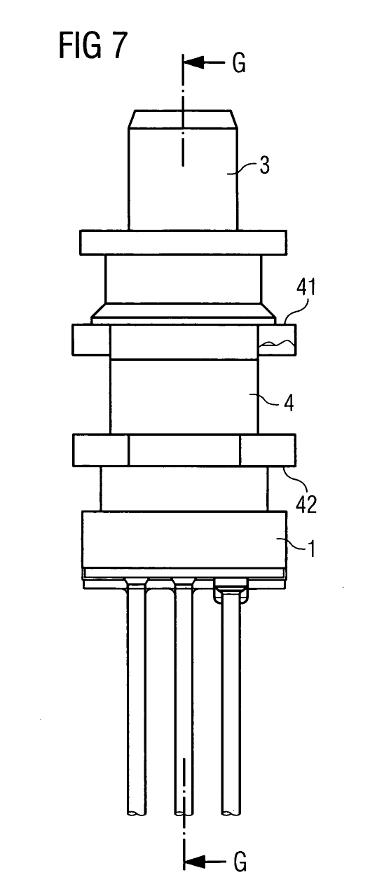

FIGS. 6 and 7 show a second embodiment of an optoelectronic device for bidirectional data transfer. As in the embodiment of FIG. 1, the module comprises a transmitting module 1, a receiving module 2, a coupling device 3 and a housing 4, to which the transmitting module 1, the receiving module 2 and the coupling device 3 are attached.

The coupling device 3 is formed as described with respect to FIG. 1, the only differences being a different peripheral contour of the coupling part 31 and a different size of the spacer 37. Also, the transmitting module 1 and the receiving module 2 are essentially identical to the transmitting module 1 and the receiving module 2 described with respect to FIG. 1. In particular, the transmitting module 1 and the receiving module 2 both have a TO-housing 11, 21 including a metallic cap 113, 213 with a glassed window 114, 214, the metallic cap 113, 213 having a weldable area at its end facing the housing 4. Inside the TO-housings 11, 21, a transmitting assembly 12 and a receiving assembly 22, respectively, are arranged.

The housing 4 of the module comprises an upper wall 4100 with an upper plane stop area 41, a lower wall 4200 with a lower plane stop area 42 and two side walls 4300, 4400. In addition, in a preferred embodiment, there is a front wall a back wall. The terms “upper, lower, side, front and back” refer to the presentation of FIG. 6. The skilled person will understand that, if the module of FIG. 6 would be oriented differently, e.g., be turned upside down, some of the terms would change.

Different than in the embodiment of FIG. 2, the lower wall 4200 forms one stop 42 area only. The upper stop area 41 serves for connection of the coupling device 3, the lower stop area 42 serves for connection with the transmitting module 1 and the receiving module 2, as discussed with respect to FIG. 2. There is an opening 45 in the top wall 4100 and there are two openings 46, 47 in the lower wall 4200. The openings 45, 46, 47 allow for the transmission of the light into and out of the housing 4.

The orientation of the axes 7, 8, 9 is the same as described with respect to the embodiment FIG. 1.

The main difference between the embodiments of FIGS. 6 and 2 lies in that the embodiment of FIG. 6 does not include a monolithic plastic part to which a WDM-filters and mirrors are attached. Instead, the beam splitting device is formed by elements 501, 502, 503, 504 which are attached to planar stop areas 411, 412, 413, 414 formed at inner sides of the housing walls. More particularly, a wavelength-selective filter (WDM-filter) 501 is attached to two stop areas 411 formed at an extension 4110 of the upper wall 4100 extending into the hollow interior 44 of the housing 4. Further, reflecting mirrors 502, 503, 504 are attached to respective stop areas 412, 413, 414 at the inside of the housing 4.

The wavelength-selective filter 501 comprises a glass lamina which has filter layers at the side facing the spacer 37. The mirrors 502, 503, 504 are formed by separate parts such as a glass lamina with mirror layers attached to the side of the glass lamina facing the light beam, such that light does not need to transmit the substrate of the mirrors. The mirrors 502, 503, 504 may be formed as metallic mirrors or as dielectric mirrors. They preferably shown optimal behaviour as to reflectivity in the wavelength area they transmit.

The attachment of the WDM-filter 501 and of the mirrors 502, 503, 504 to the respective stop areas 411, 412, 413, 414 is carried out by means of an adhesive. To this end, the stop areas 411, 412, 413, 414 comprise cutouts 401, 402, 403, 404 into which adhesive is applied. Preferably, it is used an adhesive of low viscosity which shows a good flowing behaviour. The adhesive flows in the gap between the backside of the WDM-filter or mirror and the respective stop area 411, 412, 413, 414. By means of a capillary force the adhesive pulls and holds the filter or mirror to and at the stop area 411, 412, 413, 414. This way, a very thin and even film of adhesive is formed. An angled attachment of the filter or mirror on the respective stop area 411, 412, 413, 414 is prevented.

The WDM-filter 501 is attached to two stop areas 411 formed at the extension 4110.

It is to be noted that the use of cutouts 401, 402, 403, 404 for applying the adhesive is preferable only. The adhesive may also be applied without such cutouts.

It is further to be noted that the stop areas 411, 412, 413, 414 formed at inner sides of the housing 4 implement precisely the required angle, such that a high precision reflection occurs at the mirrors and adjustment of the components 1, 2, 3 is necessary only in arrange of one to several μm. Such precision can be reached by a cost efficient, high precision master mould method, preferably by means of injection moulding using moulding powder metal.

To further improve the attachment of the WDM-filter 501 and/or the mirrors 502, 503, 504 inside the housing, it is possible to further adjust those elements at the front wall and/or the back wall. This is illustrated in FIG. 6 with respect to the attachment of the WDM-Filter 501. The back wall of the housing includes cutout 421, which serve to positively lock (form-fit) the back side of the filter 501, which—in the illustration of FIG. 6—is directed away from the plan of the drawing. Similar structures can also be implemented in the front wall of the housing and/or with respect to the mirrors.

In addition, the from and/or the back wall may include cutouts for gathering excess adhesive. Such cutouts 422, 423, 424 are shown in the back wall of the housing of FIG. 6.

It is pointed out that in the embodiment of FIG. 6 the orientation of the stop areas 411, 412, 413, 414 and, accordingly, the orientation of the WDM-Filter 501 and of the mirrors 502, 503, 504 is such that light transmitted from the transmitting module 1 to the coupling device 3 is reflected at the mirror 502 and at the WDM-Filter 501 under an angle of less 90°. Accordingly, the WDM-Filter 501 and the mirrors 502 are located at an angle different that 450 inside the housing. For light of the other optical channel transmitted from the coupling device 3 to the receiving module 2, reflection at the mirrors 503 and 504 also occurs under an angle below 90° and, accordingly, these mirrors 503, 504 are also located at an angle different than 45° inside the housing. Such reduced reflection angles include the advantage that—as the light to some extent is reflected backwards—the length of the housing 4 can be reduced, such that less space is needed when placing the module in a SFP- or SFF-housing.

A reflection of the light inside the housing under angles less than 90° can also be implemented in the embodiment of FIG. 2. In that case, also, the length of the module housing can be reduced.

In a preferred embodiment, at least one of the mirrors 503, 504 in the light path towards the receiving module 2 includes a wavelength-selective mirror (such as a dielectric filter) such that only the light to be detected by the receiving module 2 is reflected, while the mirrors 503, 504 are transparent for light of the wavelength emitted by the transmitting module 1. This way, the mirrors 503, 504 also serve as a blocking filter. This way, an additional blocking filter such as blocking filter 60 in FIG. 1 can be omitted while providing a high optical cross talk attenuation.

The operation of the module of FIG. 6 is the same as the operation of the module of FIG. 1. A first main difference is that the filter 501 and the mirrors 502, 503, 504 are attached to the inside of the housing 4 and that light between the filter 501 and the mirrors 502, 503, 504 and the openings 45, 46, 47 passes through a free beam zone. The free beam zone is provided by the hollow interior of the housing 4. A second main difference is that the angle in which the emitted or received light is reflected inside the housing is below 900.

The sequence of construction is basically the same as described with respect to the embodiment of FIG. 1 with the difference that the WDM-filter 501 and the mirrors 502, 503, 504 are first adhesively bonded to the respective stop areas 411, 412, 413, 414 of the housing interior.

The configuration of the invention is not restricted to the exemplary embodiments presented above. The person skilled in the art is aware that numerous alternative embodiment variants exist which, despite their deviation from the exemplary embodiments described, make use of the teaching defined in the subsequent claims.

By way of example, it may be provided that the transmitting module and the receiving module are not embodied in a TO design and another suitable design that provides good screening is used instead. Moreover, when using a TO housing for the transmitting module and the receiving module, the transmitting assembly and receiving assembly used in the TO housing may be formed in a different manner from that illustrated in the figures. By way of example, it may be provided that a vertically emitting laser is used instead of an edge emitting laser.

Furthermore, it is pointed out that, in principle, the bidirectional transceiver may also have a plurality of transmitting modules and a plurality of receiving modules, for example two transmitting modules and two receiving modules. The beam shaping device then has additional filters and mirror areas for additional signal separation.

In further configurations, in particular for WDM applications, the module has for example two transmitting modules or alternatively two receiving modules. Signals having two wavelengths are then multiplexed or demultiplexed by the module.

We claim:

1. An optoelectronic module for optical signals of two optical data channels, the module comprising:
a first submodule for generating or detecting first optical signals of a first data channel,
a second submodule for generating or detecting second optical signals of a second data channel,
a coupling device for coupling an optical waveguide,
a housing, to which the first submodule, the second submodule and the coupling device are mechanically fixed, and
a beam splitting device, which is arranged in the housing and effects beam splitting and light deflection in such a way that a signal transfer is effected on the one hand between the first submodule and a coupled optical waveguide and on the other hand between the second submodule and the coupled optical waveguide, wherein the first and second optical signals of both the first and second data channels are deflected a plurality of times in the beam splitting device.

2. The module according to claim 1, wherein a first optical axis of the first submodule and a second optical axis of the second submodule are parallel to one another.

3. The module according to claim 2, wherein a third optical axis of the coupling device is parallel to the first and second optical axes of the first submodule and of the second submodule.

4. The module according to claim 3, wherein the first submodule and the second submodule, on the one hand, and the coupling device, on the other hand, are fixed to the housing on opposite sides thereof.

5. The module according to claim 4, wherein the coupling device is arranged centrally with regard to the housing.

6. The module according to claim 1, wherein the housing comprises a planar outer stop area for mechanically affixing each of the first submodule, the second submodule and the coupling device, and wherein a light passage opening for enabling a passage of light into the interior of the housing is formed in the planar stop area.

7. The module according to claim 1, wherein the housing comprises a metallic housing on which the first submodule, the second submodule and the coupling device are fixedly arranged and adjusted with respect to one another.

8. The module according to claim 1, wherein the beam splitting device comprises a monolithic plastic part.

9. The module according to claim 1, wherein the first optical signals of the first data channel and the second optical signals of the second data channel are deflected twice in the beam splitting device.

10. The module according to claim 1, wherein the beam splitting device comprises a wavelength-selective filter, which is optically coupled to the coupling device, that is mechanically affixed to an obliquely running area of the beam splitting device, is transmissive to the optical signals of one of the first and second data channels and is reflective to the optical signals of the other of the first and second data channels, the optical signals being reflected between the wavelength-selective filter and the associated module for each data channel at at least one obliquely running reflective area of the beam splitting device.

11. The module according to claim 10, further comprising a glass lamina with a mirror for beam deflection in each case, the glass lamina being arranged at an obliquely running reflective area.

12. The module according to claim 10, wherein the wavelength-selective filter is formed on a glass lamina arranged at the associated obliquely running area of the beam splitting device.

13. The module according to claim 11, the glass lamina in each case being adhesively bonded onto the associated obliquely running area by a transparent, index-matched adhesive.

14. The module according to claim 10, wherein the optical signals of one of said first and second data channels that has been transmitted through the wavelength-selective filter is coupled to the associated module by two further obliquely running reflective areas of the beam splitting device.

15. The module according to claim 14, wherein the optical signals of the other data channel that has been reflected at the wavelength-selective filter is coupled to the associated module by a further obliquely running reflective area of the beam splitting device.

16. The module according to claim 1, wherein the housing includes one or several walls surrounding a hollow interior and wherein the beam splitting device consists of components located inside the hollow interior and attached to the inside of said wall or walls.

17. The module of claim 16, wherein the components comprise at least one wavelength selective filter and a plurality of mirrors.

18. The module of claim 17, wherein the wavelength selective filter and the mirrors are attached to planar stop areas formed at the inside of said walls or walls.

19. The module of claim 18, wherein at least one the planar stop areas includes a cutout filled with an adhesive which serves into adhesively bond the respective filter or mirror to the respective planar stop area.

20. The module of claim 16, wherein at least one sidewall of said housing includes structure to positively lock a side area of at least one of said filters and mirrors.

21. The module of claim 18, wherein there are provided four stop areas, a first of said stop areas carrying a wavelength selective filter and the other stop areas each carrying a mirror, wherein the wavelength-selective filter is transmissive to the optical signals of one of the first and second data channels and is reflective to the optical signals of the other of the first and second data channels, the optical signals being reflected between the wavelength-selective filter and the associated submodule for one of the first and second data channels by first and a second obliquely arranged mirrors and for the other of the first and second data channels by a third obliquely arranged mirror.

22. The module of claim 17, wherein the mirrors each include a glass lamina and mirror layers located at the side of the glass lamina directed towards the hollow interior.

23. The module of claim 17, wherein at least one mirror of at least one data channel is a wavelength-selective mirror which is reflective for the light of the respective data channel and not reflective for light of the respective other data channel.

24. The module of claim 16, wherein optical signals are transmitted between components of the beam splitting device through the hollow interior of the housing.

25. The module of claim 1, wherein optical signals of at least one of the first and second data channel are reflected at a component of the beam splitting device at an angle below 90°.

26. The module of claim 25, wherein optical signals of each of the first and second data channel are reflected twice by components of the beam splitting, each reflection taking place at an angle below 90°, and wherein the optical signals after the twofold reflection run exactly parallel to their original direction.

27. The module of claims 21, wherein optical signals of the first data channel are reflected at the wavelength-selective filter at an angle below 90° and are reflected at the third mirror at an angle also below 90°, and wherein optical signals of the second data channel are reflected at the first mirror at an angle below 90° and are reflected at the second mirror at an angle also below 90°.

28. The module according to claim 1, wherein the first submodule comprises a TO module with a TO housing and a transmitting or receiving assembly arranged in the TO housing, and wherein the TO housing forms a stop area with which it is mechanically affixed to a planar outer stop area of the housing.

29. The module according to claim 1, wherein the second submodule comprises a TO module with a TO housing and a transmitting or receiving assembly arranged in the TO housing, and wherein the TO housing forms a stop area with which it is mechanically affixed to a planar outer stop area of the housing.

30. The module according to claim 1, wherein the coupling device comprises an integrated fiber stub and a lens for shaping light emerging from the fiber stub to form a parallel beam of rays.

31. The module according to claim 1, wherein the housing comprises a width of at most 14 mm.

32. The module according to claim 1, wherein the first submodule comprises a transmitting module and the second submodule comprises a receiving module.

33. An optoelectronic module for processing optical signals transmitted on two optical data channels, the module comprising:
a housing including one or more outer walls surrounding a hollow interior;
a first submodule mounted on the housing and including means for transmitting first optical signals into the hollow interior along a first optical axis;
a second submodule mounted on the housing and including means for detecting second optical signals transmitted in the hollow interior along on a second optical axis;
a coupling device including an optical waveguide defining a third optical axis; and
a beam splitting device mounted in the hollow interior of the housing and including first reflecting means for reflecting the first optical signals from the first optical axis to the third optical axis, and second reflecting means for reflecting the second optical signals from the third optical axis to the second optical axis.

34. The module of claim 33, wherein the first reflecting means and the second reflecting means include components located in the hollow interior of said housing at the inside of at least one of said outer walls.

35. The module of claim 34, wherein the first reflecting means comprises a wavelength-selective filter and at least one mirror and the second reflecting means comprises a plurality of mirrors, said wavelength-selective filter and said mirrors being located in the hollow interior of said housing at the inside of at least one of said outer walls.
